(19) United States
(12) Patent Application Publication
(10) Pub. No.: US 2026/0044144 A1
(43) Pub. Date: Feb. 12, 2026

(54) AUTOMATIC RECOGNITION OF AN ANOMALY IN A MACHINE OPERATION

(71) Applicant: Krones AG, Neutraubling (DE)

(72) Inventors: Sebastian LANGWIESER, Abensberg (DE); Markus ZOELFL, Metten (DE); Dominik RAMSAUER, Stamsried (DE)

(21) Appl. No.: 19/291,065

(22) Filed: Aug. 5, 2025

(30) Foreign Application Priority Data
Aug. 7, 2024 (DE) 102024122525.4

(51) Int. Cl. G05B 23/02; B65B 57/00

(52) U.S. Cl. CPC G05B 23/0289; B65B 57/00; G05B 23/0221; G05B 23/0281

(57) ABSTRACT

The disclosure relates to a method, a computer apparatus and a system for automatically recognizing an anomaly in a machine operation. The machine operation is, in particular, of machines for filling and packaging food and/or beverages. Anomaly recognition comprises the capturing of sensor data, the automatic categorization of these data according to operating states and the extraction of relevant features for each category of operating states. Threshold values are specified with the aid of statistical methods in order to define precise operating limits. This model is monitored and adjusted in order to respond to anomalies at an early stage and ensure operational safety. The disclosure creates a robust monitoring system that makes it possible to monitor the condition of the machine system in real time and respond at an early stage to deviating operating conditions. This contributes to increasing operational safety, avoiding downtime and optimizing maintenance processes.

### CROSS REFERENCE TO RELATED APPLICATION

The present application claims priority to German Patent Application No. 10 2024 122 525.4 filed on Aug. 7, 2024. The entire contents of the above-listed application are hereby incorporated by reference for all purposes.

### TECHNICAL FIELD

The disclosure relates to a method, a computer apparatus and a system for automatically recognizing an anomaly in a machine operation, in particular for machines for filling and packaging food and/or beverages.

### BACKGROUND

Monitoring machine systems and ongoing machine operation is an important component of industrial production and particularly important in maintenance. It is essential to continuously monitor the operating state of the machines in order to, at an early stage, recognize anomalies that indicate possible malfunctions or impending failures. Traditionally, the monitoring of machine systems is achieved through periodic manual inspections and simple alarm systems that respond to specified threshold values. However, these methods are increasingly reaching their limits, in particular in complex and dynamic production environments. Such a production environment is, for example, found in a machine line for packaging and filling food products, such as beverages.

### SUMMARY

Conventional approaches to monitoring machine systems are usually based on time-controlled inspections and maintenance measures. Technicians perform regular checks to identify, for example, visible signs of wear and tear and abnormalities. However, this approach is time consuming and not always reliable, since many potential problems can only be recognized at a late stage, when they have already led to damage, inefficient operation or even failures.

Another well-known approach is the use of simple alarm systems that respond to specified threshold values. For example, temperature or vibration sensors can sound an alarm if certain limit values are exceeded. However, these systems are often unable to recognize subtle anomalies that indicate gradual deterioration. In addition, they require manual specification of threshold values, which are not always optimally adapted to the specific conditions and requirements of the particular application.

There is therefore a need for improved methods, computer apparatuses and systems for the automatic and generic recognition of an anomaly in a machine operation.

This object is achieved according to the disclosure by a method, a computer apparatus, and a system as described herein.

One embodiment of the disclosure relates to a method for automatically recognizing an anomaly in a machine operation. The machine operation can be particularly for machines for filling and packaging food and/or beverages. The method comprises a first step in which signals from the machine are captured over a predetermined reference period. The captured signals are thus time series data of the machine. This is followed by an automatic categorization of the captured signals into a plurality of process type groups. Categorization is based on process variables. For example, the captured variables can be automatically categorized based on the operating states of the machine. This can be carried out by analyzing the operating conditions and assigning the data to corresponding categories.

Features can then be determined for each of the process type groups. This corresponds to a so-called “feature extraction. ” Relevant features are extracted from the categorized data. These features can comprise statistical parameters, such as means, variances, peaks, frequency components, etc. A correlation analysis of the extracted features can subsequently be performed in order to identify relationships and dependencies between the variables/signals.

In the next step of the method, threshold values are determined for each of the specific features for each of the process type groups. Since the features are statistically normalized, these threshold values can be defined automatically for features of all signals. This can be a simplification in the method compared to manually defining threshold values on the original signals. These threshold values define the normal operating limits of the system. The resulting model can be implemented in the machine and optionally continuously monitored and retrained where necessary in order to account for changes in system behavior.

The signals of the machine are then continuously monitored during the ongoing operation of the machine based on the determined threshold values of the specific features. If a signal (or a plurality of signals) of the machine reaches one of the threshold values during ongoing operation, an anomaly in the machine operation can be recognized. For example, at least one anomaly can be recognized if a feature reaches the threshold value, or if at least half of the features reach their corresponding threshold values, or if all features reach their corresponding threshold values, etc. In this way, a sensitivity of the method can be set. The recognition of the anomaly can lead to a corresponding message from an operator.

Further embodiments relate to a computer apparatus and a system in which the above object is achieved.

### BRIEF DESCRIPTION OF THE FIGURES

Example aspects of the disclosure are shown in the drawings, in which:

FIG. 1: shows a flow chart showing an exemplary method for automatically recognizing anomalies;

FIG. 2: shows an exemplary histogram in which threshold values for anomaly monitoring are plotted;

FIG. 3: shows an exemplary plant configuration for polyethylene terephthalate (PET) containers and adhesive containers;

FIG. 4: shows an exemplary plant configuration for PET containers and shrink packers;

FIG. 5: shows an exemplary plant configuration for cans or glass bottles; and

FIG. 6: shows an exemplary plant configuration for cans.

### DETAILED DESCRIPTION

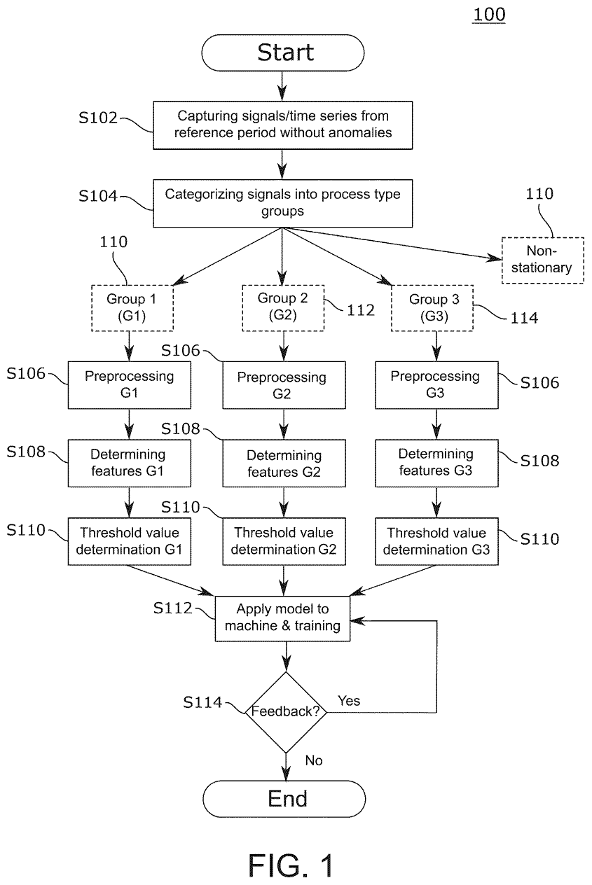

FIG. 1 shows an exemplary method by which anomalies in a machine operation can be automatically and intelligently captured, detected and reported.

In a first step S102, signals from a reference period are captured. For example, data from various sensors and measuring devices of the machine system can be continuously captured during a defined reference period. These variables can comprise various physical quantities, such as temperature, power consumption, pressure, vibrations, etc. The capturing of these sensor signals over the reference period thus results in different time series data of available sensor data. The data can, for example, be read from the sensors and stored in a database for later analysis.

For example, the reference period can be specified manually. Preferably, the reference period is selected so that the recording of the sensor data relates to a machine operation in which no anomalies in operation occur. This can, for example, be a normal production phase over a longer period of time, such as several weeks, in order to generate a certain amount of time series data. Due to a reference period that is sufficiently large, it is ensured that various process dependencies are included in the sensor signals, such as different operating states, idle states, maintenance states, cleaning phases, different operating personnel and/or different product processing. In alternative embodiments, the selection of reference periods can also occur dynamically. As a result, the reference period is continuously updated as a sliding window.

Due to the recording/capturing of the sensor signals during the reference period, a large amount of time series data is created. For example, a machine in a filling plant can generate as many as 4,000 signals, which are recorded in time series data over the reference period, such as temperature values of individual stations, status data of individual modules in the machine, and so on.

These signals or time series data are then categorized into different process type groups in step S104. This categorization is based on process variables, as a result of which the recorded time series data are divided into different operating modes and (production) process steps, for example. This can be carried out automatically and corresponds to a classification of the signals into different behaviors of the machine. Thus, the signals can be divided into different time segments, such as a running operating state of the machine, idle data of the machine, etc. The categorization can be carried out, for example, by analyzing the operating conditions and assigning the data to corresponding categories.

In principle, only data that exhibit stationary behavior, i.e. that represent a naturally oscillating signal, are used for anomaly detection. For example, an augmented Dickey-Fuller test (ADF) can be used to test whether the time series data comprise a stationary signal or a non-stationary signal, such as meter data. Non-stationary signals/data 110 can be discarded, since they do not play a role in the further process.

All other signals/time series data, i.e., stationary ones, are classified into the various groups 1 to 3 (groups 110 to 114) according to the categorization. Groups 1 to 3 are only exemplary and there may be more or fewer groups. For example, there may be only one group.

Optionally, in step S106, there may be preprocessing of the time series data of the individual groups G1 to G3. In preprocessing, the data can be cleaned, for example, which corresponds to filling or removing non-existent data, or a resampling of the data can be performed. Furthermore, the individual groups can also be filtered or classified according to predefined criteria, such as operating states/programs, speed windows, etc. The preprocessing in S106, for example, is a purely data-driven method in which the data are processed so that each signal has a similar data structure.

In step S108, features are determined from the different groups G1 to G3 (feature extraction). Here, initially, feature extraction is carried out from the captured raw sensor data. This raw data, which are continuously captured by the various sensors, can, for example, be divided into fixed time windows. This may, for example, be part of the preprocessing in step S106. For each of these time windows, specific statistical features are then extracted to serve as features. These features form the basis for subsequent correlation analysis and modeling.

This determination of features corresponds to a statistical processing of the original signal, such as the course of a standard deviation of the signal. For example, the specific features (i.e., the extracted features) can comprise statistical parameters, such as means, variances, peaks, frequency components, etc. A correlation analysis of the extracted features can be performed in order to identify relationships and dependencies between the variables or the individual signals. The correlation analysis can, based on statistical significance, lead to the exclusion of individual features. For example, after specifying a significance level, non-significant features can be discarded.

The feature time series extracted in this way form the basis for a deeper analysis and monitoring of the machine system. This deeper analysis of the features also makes it possible to compare machines of similar types, since the features are more robust compared to the original signals. In turn, this enables insights into how the method should be specifically configured. They provide insights into normal operating conditions and help recognize deviations at an early stage. Due to the identification of correlations between features, complex relationships and potential causes of anomalies can be uncovered.

Once the feature time series of each group G1 to G3 have been created, corresponding threshold values for each of the groups G1 to G3 can be determined in step S110. Specifying or determining threshold values for the monitored signals serves to reliably recognize anomalies and potential malfunctions. These threshold values define the operating limits within which the machine system is in normal state. Various statistical methods can be used to set threshold values, which are based on statistical analyses of the measured data and therefore do not necessarily have to be defined manually.

One approach according to embodiments of the disclosure is to create histograms of the captured sensor data and to analyze the distribution of the data.

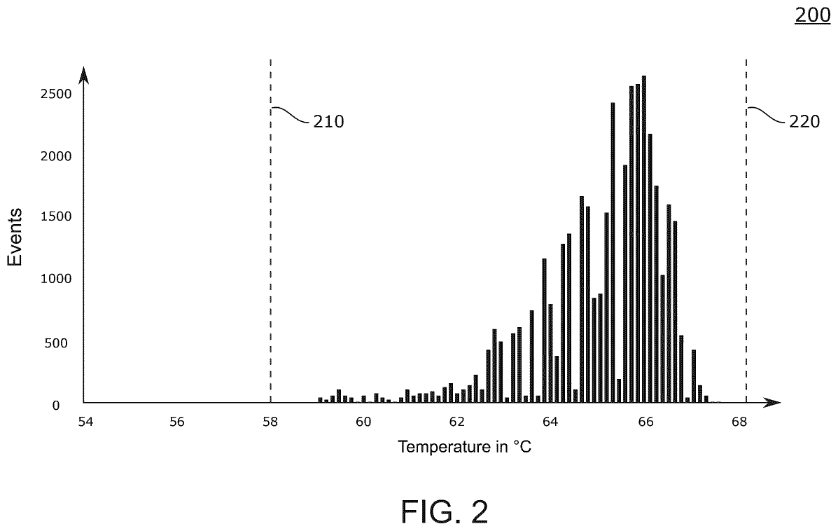

For symmetric distributions of sensor values, such as the Gaussian distribution, threshold values can be set by adding or subtracting one or more standard deviations in both directions from the mean. However, this method does not work optimally for asymmetric distributions, such as in the example of a right-skewed signal distribution, such as the temperature distribution shown in FIG. 2. Here, such an approach would make sense on the right side, but would be less suitable on the left side, since the distribution is flatter there.

The exemplary histogram in FIG. 2 shows the distribution of possible temperature measurements. For example, the temperature values could have been measured by a sensor at a specific critical point in a filling plant. As can be seen in FIG. 2, the distribution is left-skewed, which means that the majority of the measured values tend to show higher temperatures. In such a case, the mode (the most frequent value) is shifted further to the right.

In order to set precise threshold values even for asymmetric distributions, a kernel density estimation (KDE) can be performed. The KDE method can be used to estimate the density distribution of the data, as a result of which the shape of the distribution is better captured. This method makes it possible to reliably determine threshold values even for non-normally distributed data. Purely by way of example, FIG. 2 shows two threshold values defined by the system in this way, i.e. a lower threshold value 210 at 58.0° C. and an upper threshold value 220 at 68.2° C. These threshold values are only exemplary.

Due to the application of the kernel density estimation, the limits that define the normal operating conditions of the system can be precisely determined. This technique takes into account the actual distribution of the data and makes possible a flexible and accurate setting of threshold values that is adjusted to the specific properties of the measured variables.

Thus, the total number of threshold values determined in this way for the different features in the individual groups forms a model of the machine system that can be implemented in order to monitor the machine and recognize anomalies in a generic manner. This occurs in step S112, in which the model is applied to the corresponding machine. The implementation of the model can, for example, comprise a configuration file, in which all threshold values and grouping options are defined.

The configuration file or model can, for example, be implemented in a controller or a computer apparatus that is functionally connected to the machine. The computer apparatus comprises at least standard components, such as memory, processor, input and output units, at least one network interface, etc. The computer apparatus can thus monitor the relevant signals of the machine during ongoing operation of the machine based on the determined threshold values of the specific features. If a signal from the machine reaches one of the threshold values during ongoing operation (e.g., exceeds or falls below it), an anomaly in the machine operation is recognized and can be reported to an operator.

The message or notification to the operator is carried out by a logically interpretable statement to the operator, such as “The temperature in module X is higher than normal”. This can then be remedied by the operator before damage or failure occurs.

In step S114, feedback can optionally be obtained from the machine, which feedback can be used for training the model in connection with step S112.

In some embodiments, instead of reporting an anomaly to an operator (or in addition to the report), one or more control parameters of the machine can be automatically adjusted in order to respond to an anomaly. For example, the model may already contain additional measures/control structures that need to be undertaken when certain threshold values are reached.

Some examples in a beverage filling plant in which the embodiments of the disclosure can be implemented are, for example, a flow rate monitoring system, an idle monitoring system for a servo drive, a chain drive for a cleaning machine, a temperature monitoring system for a cleaning machine, and/or a vibration analysis system for a blow molding machine.

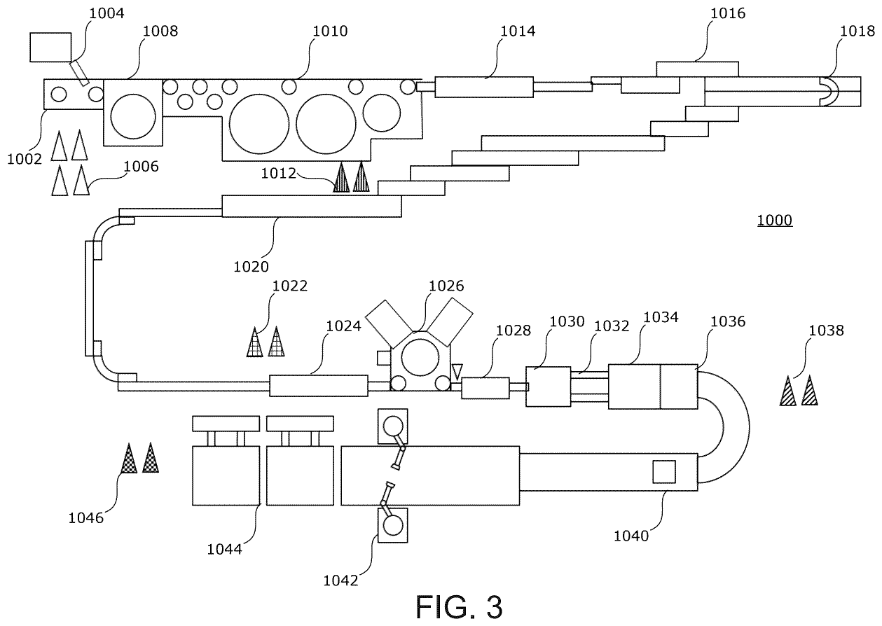

In the following FIG. 3 to FIG. 6, various exemplary plant configurations for different bottle filling plants are described in which the disclosure or at least parts and aspects of the disclosure can be implemented. The description of FIG. 3 to FIG. 6 is intended only to provide a general overview of machines in which generic anomaly recognition can be implemented.

In principle, modern systems, as shown in FIG. 3 to FIG. 6, use a variety of sensors in order to continuously capture data and analyze them in real time. These data comprise a wide range of measurements, such as temperature, pressure, current consumption, vibrations and more.

FIG. 3 shows an exemplary plant configuration 1000 for polyethylene terephthalate (PET) bottles or PET containers and adhesive containers. As can be seen in FIG. 3, the plant configuration 1000 comprises the most varied modules, which form a line at the end of which the ready-filled PET containers are dispensed in the form of a bundle on pallets. Some of the modules and machines can be optional, and the disclosure is not limited to the exact shape and arrangement of the plant configurations.

The plant configuration 1000 comprises a furnace 1002 for preforms, a preform sorting system with a feeding machine 1004, and a blow-molding machine 1008. Modules 1002, 1004, and 1008 form in general a stretch blow-molding machine in which PET containers are manufactured and formed from a raw material. The produced PET containers are forwarded to a filler 1010 in which the bottles are filled. The filler can optionally comprise a rinser. Various particles such as dust, cardboard, or remains of wooden pallets can collect in the preforms during storage or transport. These can be removed with the rinser. At the end of the filler, a closer can be arranged, using which the PET containers are closed after filling.

Optionally, the plant configuration 1000 can, after the filler 1010, comprise a rotating apparatus, which is used for hot filling of the PET containers. The filled PET containers are guided to a separator 1020 and further to a drying apparatus 1024 in which the PET containers are dried via one or more conveyor belts 1016, which can also comprise a buffer 1018 for intermediate loading of filled containers.

After drying, the PET containers are conveyed to a labeling machine 1026. The labeling machine 1026 can be configured for various labeling techniques such as labeling using hot glue, cold glue, self-adhesive labels, or sleeves. After printing or labeling the PET containers, the PET containers are passed through a second drying apparatus 1028, a line distributor 1030, conveyor belts 1032, adhesive container production 1034, and a curing section to a handle applicator. In adhesive packaging production 1034, the PET containers are grouped together in certain group sizes and packaged into a pack such as a “six-pack”. In the handle applicator, a carrying handle is attached to the pack, which allows the pack to be carried comfortably. The finished packs are then accordingly arranged by a robot 1042 for layer production and packed on pallets by a palletizer 1044.

In the plant configuration 1000, so-called format trolleys or format racks can be arranged on various modules and machines in order to provide quickly changeable format sets for short changeover times and automatic tool exchange. Examples of format trolleys are the format trolley 1006 for the blow-molding machine 1008, the format trolley 1012 for the filler 1010, the format trolley 1022 for the labeling machine 1026, the format trolley 1038 for the adhesive packaging production 1034, and the format trolley 1046 for the palletizer 1044.

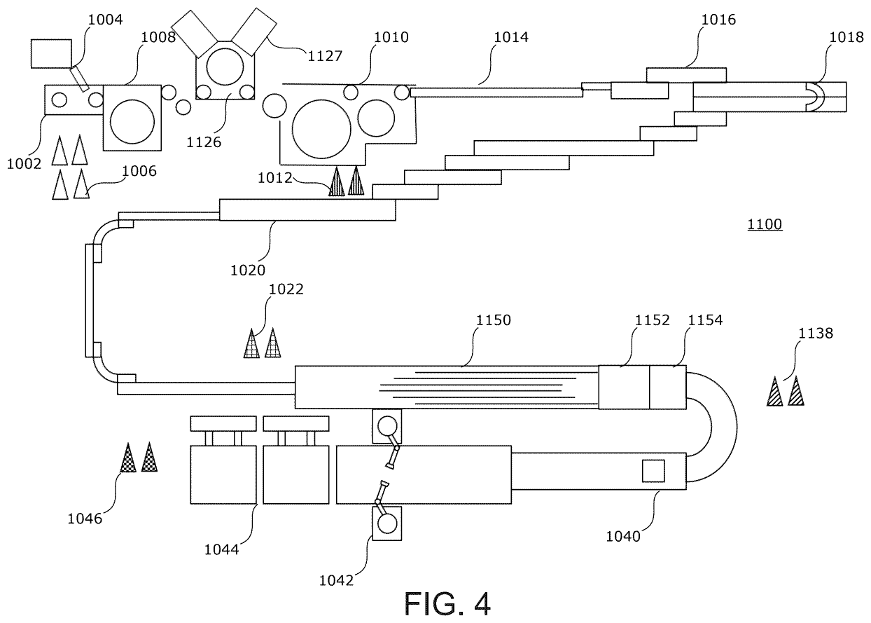

FIG. 4 shows another exemplary plant configuration 1100 for PET containers and shrink packers. The plant 1100 in FIG. 4 comprises many of the modules and machines from the plant configuration 1000 in FIG. 3, but there are some differences. The description of the modules that are already described in connection with FIG. 3 is therefore omitted for FIG. 4.

A key difference between the two exemplary plant configurations 1000 and 1100 is that the labeling machine 1126 with the labeling modules 1127 can already be installed after the blow-molding machine 1008 and before the filler 1008. For this purpose, the plant configuration 1100 can comprise six transport lanes 1150 into which the PET containers can be pushed. After the PET containers have been correspondingly pushed into one of the six lanes 1150, they are conveyed into the film wrapping module 1152 and then into the shrink tunnel 1154.

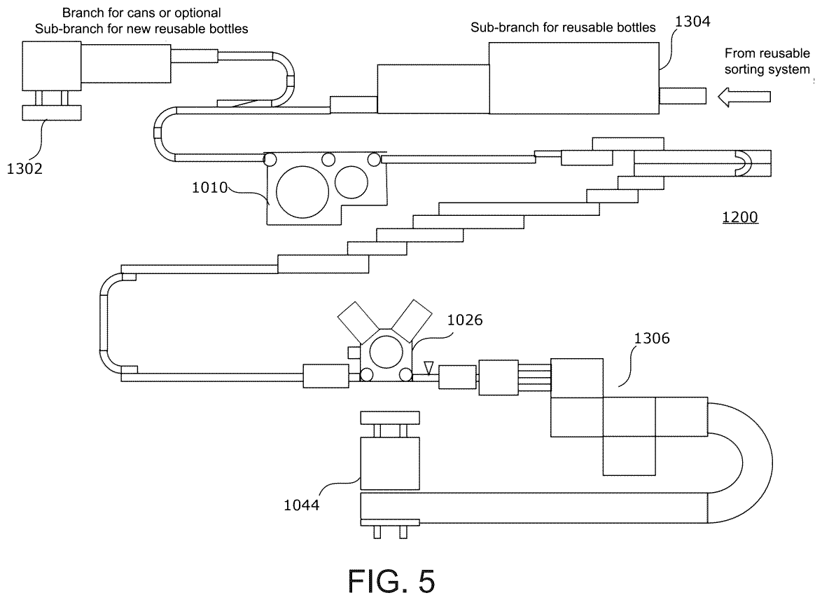

FIG. 5 shows an exemplary plant configuration 1200 for cans or glass bottles. The exemplary plant configuration 1200 from FIG. 5 again has some similarities to the plant configurations 1000 and 1100 from FIG. 3 and FIG. 4, and the description of the plant configuration is therefore limited to the differences between the plant configurations.

As shown in FIG. 5, the exemplary plant configuration can comprise two separate feeds. A first feed, on the left in FIG. 5, shows a branch for cans or, optionally, a partial branch for reusable new bottles. The containers, i.e., cans or new bottles, are fed from a depalletizer 1302 into the machine, where they are guided via conveyor belts to the filler 1010. A second feed, on the right in FIG. 5, shows a partial branch for reusable bottles, which are introduced into the plant from a reusable sorting plant (not shown).

In the case where the reusable bottles that have already been used are introduced into the plant 1200 via the sub-branch for reusable bottles, the reusable bottles first pass through the cleaning machine or washing machine 1304. Another possible difference of the exemplary plant configuration 1200 is the transfer packer 1306 after the labeling machine 1026. The transfer packer can sort the bottles or cans into a carton clip application or into boxes, or both.

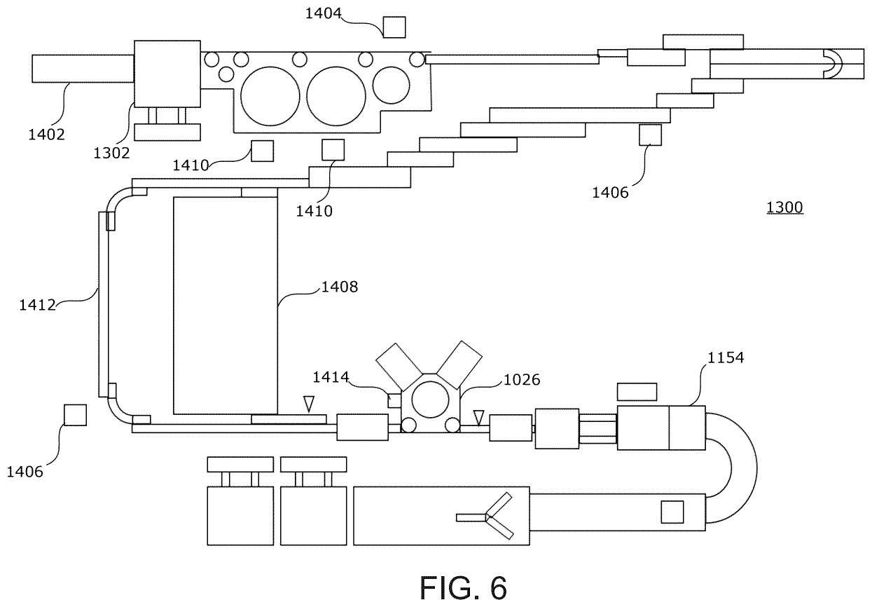

FIG. 6 shows an exemplary plant configuration 1300 for cans, in which the elements already described in the other plant configurations are not described. The cans in the plant configuration 1300 are introduced from a magazine 1402 with cans into the depalletizer 1302. The cans, after they have passed through the filler and are filled, are closed by a closure magazine 1404 and are then transported further along the plant 1400 via the conveyor belts as described above.

The optional pasteurizer 1408 can be circumvented via the bypass 1412 if it is not required. In the pasteurizer 1408, the freshly filled products can be pasteurized for preservation.

In contrast to the plant configurations 1000, 1100, and 1200, the exemplary plant configuration 1300 shows various tanks for corresponding consumables, such as the tanks 1410 with rinsing liquid and/or the filling product, and the tanks 1406 with belt lubricant. These tanks can also be contained in the above-described exemplary plant configurations. For example, the chemical products 106 that are fed from the mixer 110 to the machines can be stored in the tanks 1406 and 1410.

1. A method for automatically recognizing an anomaly in operation of a machine, wherein the method comprises:
capturing signals of the machine over a predetermined reference period, wherein the captured signals are time series data of the machine;
automatically categorizing the captured signals into a plurality of process type groups, wherein the categorization is carried out based on process variables;
determining features for each of the process type groups;
determining at least one threshold value for each of the determined features for each of the process type groups;
monitoring signals from the machine during ongoing operation of the machine based on the determined threshold values of the determined features; and
if a signal from the machine reaches one of the threshold values during ongoing operation, recognizing an anomaly in operation of the machine.

2. The method according to claim 1, further comprising:
adjusting at least one control parameter of the machine based on the recognized anomaly.

3. The method according to claim 1, further comprising:
preprocessing of the categorized signals, comprising:
dividing the time series data into equal-sized windows, and
cleaning the time series data.

4. The method according to of claim 1, wherein automatically categorizing the captured signals into the plurality of process type groups is data driven and further comprises:
testing the captured time series data as to whether or not the signals are stationary;
discarding non-stationary time series data; and
classifying the remaining time series data into the process type groups based on one or more process variables, wherein the one or more process variables describe a current operating mode of the machine.

5. The method according to claim 1, wherein determining features for each of the process type groups further comprises:
defining a measure of statistical significance;
performing an automatic correlation analysis for each of the categorized time series data; and
discarding categorized time series data that do not meet the defined measure of statistical significance.

6. The method according to claim 1, wherein determining at least one threshold value for a feature is based on a probability distribution of the feature and comprises a kernel density estimation.

7. The method according to claims 1, further comprising:
creating a model based on an entirety of all determined time series threshold values;
applying the model in the machine; and
training the model created based on feedback from the machine.

8. The method according to claim 1, wherein the machine and/or a process of the machine that is being monitored for anomalies is:
a monitoring system of a flow rate; or
an idle monitoring system for a servo drive; or
a chain drive for a cleaning machine; or
a temperature monitoring system for cleaning machines; or
a vibration analysis of a blow molding machine.

9. A computer apparatus for automatically recognizing an anomaly in operation of a machine for filling and packaging food and/or beverages, wherein the computer apparatus comprises:
a memory for storing computer code; and
a processor for executing the computer code, wherein the computer apparatus is configured to carry out the method according to claim 1.

10. A system for automatically recognizing an anomaly in operation of a machine for filling and packaging food and/or beverages, wherein the system comprises:
at least one machine; and
the computer apparatus according to claim 9.

11. The method of claim 1, wherein the machine fills and packages food and/or beverages.
